(19) United States
(12) Patent Application Publication
(10) Pub. No.: US 2006/0236589 A1
(43) Pub. Date: Oct. 26, 2006

(54) Fisherman's tackle box

(76) Inventors: Harold Warren Boyette, Asheville, NC (US); Michael Mckinley Stanberry, Asheville, NC (US)

Correspondence Address: Harold W. Boyette, 234 Pisgah View Rd., Asheville, NC, 28806, US

(21) Appl. No.: 10/992,589

(22) Filed: Apr. 26, 2005

(51) Int. Cl. A01K 97/06; A01K 97/04

(52) U.S. Cl. 43/54.1; 43/55

(57) ABSTRACT

Fisherman's Tackle Box would consist of a large, rectangular tackle box. The tackle box would be equipped with an outer housing made from a weather-resistant, impact-resistant plastic, metal latches, a rectangular lid, a cooler with artificial ice packs, fishing rod holders and a storage compartment for live bait. The tackle box would also include drawers with compartments for holding hooks, weights, sinkers, and lures, a detachable fishing stool attached to the rear of the tackle box, a carrying handle, hooks, a side-mounted utility holder for knives or other hand tools, a side-mounted holder for miscellaneous items, two doors with pockets for lures, a spool holder for four to five spools of fishing line, small holes in the lid to allow fishing line to pass through, a bar in which the line passes through, and a line tensioner to hold the line in place, a cover for the handle and the line holder and a ruler for measuring fish.

### BACKGROUND OF THE INVENTION

1. Field of the Invention

The present invention relates generally to fishing equipment and more particularly, to an improved apparatus which serves as a fishing tackle box with a line dispenser, and many other features that provide a greater convenience for fisherman.

2. Discussion of the Related Art

On a fishing trip, fishermen commonly carry a wide variety of items. For example, a fisherman needs a fishing rod and a tackle box as well as fishing line, hooks, weights, sinkers, live bait and lures in various shapes and forms. Many fishermen also bring along items for their personal comfort, such as snacks and drinks in cans or bottles However, carrying all of these items from a parking lot to a fishing area can be a problem because all of a fisherman's supplies may be too difficult to carry in one trip. As a result, the fisherman may need to make at least two trips to convey supplies to a fishing area; these trips can waste valuable time. The Fisheman's Tackle Box would provide an innovative alternative to conventional tackle boxes in the form of a specially designed tackle box which will provide greater convenience for fishermen. It would allow a fisherman's supplies to be more easily carried from one location to another and would be produced from high-quality, durable materials. Also, Fisherman's Tackle Box would be simple to use and would fit easily into a car trunk or a truck bed.

### SUMMARY OF THE INVENTION

It is the object of the present invention to provide a combination fishing tackle box with line dispenser, cooler, fishing stool, and many other features of convenience. It is also an object of the present invention to provide a device that does not require a power source. The design of the Fisherman's Tackle Box calls for materials such as plastic and metal to be utilized as the major components. Fisherman's Tackle Box would consist of a large, rectangular tackle box. The tackle box would measure 24 inches in overall length, 12 inches in overall width, 16 to 19 inches in overall height and one-eighth to one-fourth of an inch in thickness.

The tackle box would be equipped with an outer housing made from a weather-resistant, impact-resistant plastic, metal latches, a rectangular lid, a cooler with artificial ice packs, fishing rod holders and a storage compartment for live bait Other features of Fisherman's Tackle Box would include three 24 inch by three-inch drawers with compartments for holding hooks, weights, sinkers and lures, a detachable fishing stool attached to the rear of the tackle box, a carrying handle, hooks, a side-mounted utility holder for a utility knife or other hand tools, a side-mounted holder for miscellaneous items, two doors with pockets for lures, a spool holder for four to five spools of fishing line, small holes in the lid to allow fishing line to pass through, a cover for the handle and the line holder and a 14 inch ruler for measuring fish. Leader hooks are also included.

The plastic components of Fisherman's Tackle Box could be formed with the use of injection molding or blow molding. Injection molding requires that melted plastic be forcefully injected into relatively cool molds. As the plastic begins to harden, it takes on the shape of the mold cavity and, when cool, requires few postmolding operations. Other advantages of this process include its sp of production and its ability to allow multiple parts to be simultaneously molded

Blow molding in the production of plastic shapes is a form of extrusion, a major technique in the plastics industry. Extrusion is used to push a molten tube, called a parison, into a bottle-shaped mold. Compressed air then forces the parison against the cold walls of the mold.

Molds are generally side fed, with the thickness controlled by a tapered mandrel (core) or a variable-orifice die. Continuous extrusion of the plastic is possible through the use of multiple blow molds.

To use Fisherman's Tackle Box, a fisherman would fill up the tackle box with supplies and carry it to a fishing area. When needed, the tackle box could be opened and supplies in the tackle box could be used as needed. After use, the tackle box could be closed for storage.

### BRIEF DESCRIPTION OF THE DRAWINGS

The accompanying drawings, which are included to provide a further understanding of the invention and are incorporated in and constitute a part of this specification. These illustrations provide a clearer view of the invention and, together with the description, serve to explain the principles of the invention

FIG. 1 illustrates a view from the front of the tackle box with line dispenser. This illustration also gives a view of the drawers that house, hooks, weights, sinkers and lures. This illustration also provides a view of the inside of the door which houses lures. This illustration also provides a view from the front and the side of the cooler with said latches on the cooler portion of the tackle box. Also in this view you can see the leader hooks used for holding lures and leaders. This view also shows the side-mounted utility holder for knives or other hand tools, and a view of the storage compartment on the inside of the tackle box. One can also see the carrying handle and the rod holder. One can also see the bar in which the fine is fed through into the line tensioner for holding the line.

FIG. 2 illustrates a rear view of the tackle box with fishing stool attached to the box. One can also get a better view of the ruler attached to the top of the tackle box.

FIG. 3 illustrates a separated view of the upper housing of the tackle box and the lower housing of the tackle box which is the cooler. This illustration also provides a view of the lids that place the cooler in a scaled position. An illusion of the cooler dividers are also provided in this view.

FIG. 4 illustrates a side view of the tackle box with respect to the assembly of the line spool, line spool rod, line spool rod guides, the drawers and drawer guides, a view of the leader hooks is also provided. A clear side view of the cooler divider and lid are also illustrated A side view of the latches are provided. A view of the line passing through to the line hole, into the bar and the line tensioner.

FIG. 5 illustrates an internal open view from the front of the tackle box, viewing all compartments of storage, the line spool holder, drawers and all aspects of the cooler.

### DETAILED DESCRIPTION OF THE PREFERRED EMBODIMENTS

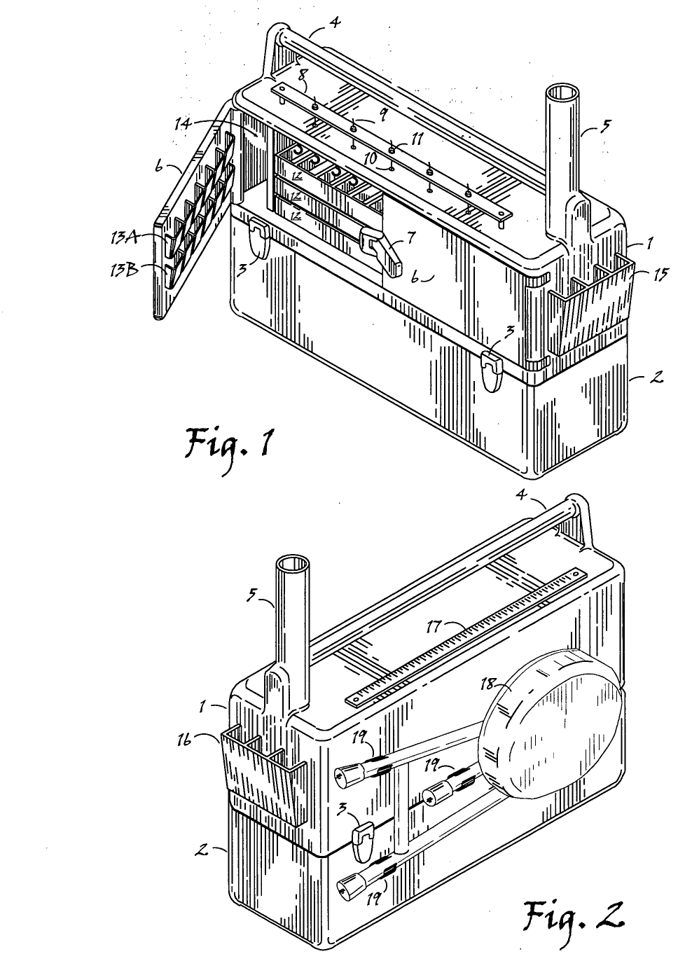

With reference to the drawings, in particular to FIGS. 1-5, a fishing tackle box with line dispenser, and cooler embodying the principles and concepts of the present invention will be described.

FIG. 1 illustrates a view from the front of the tackle box with line dispenser according to a fist embodiment of the present invention. Referring to FIG. 1, the present invention comprises a tackle box 1 which is of a rectangular configuration. The upper housing 1 view the latches 3 which make the upper housing 1 and the lower housing 2 in a closed position. The handle 4 is for carrying the tackle box. The rod holder 5 is for housing the fishing pole. The doors 6 open to provide a view of the drawers 12, and the pockets 13A, 13B, which house lures. The doors 6 can be closed with a latch 7 to make this part of the tackle box closed. The bar 8 is equipped with the line tensioner 11 to hold line 9 in place. The upper housing 1 also provides a view of the line hole 10 in which the line 9 passes through in to the bar 8 and is held in place with the line tensioner 11. The upper housing 1 also provides a view of the storage compartment 14 for miscellaneous storage. FIG. 1 also illustrates a view from the fin and incorporates a side view of the cooler 2. Also provided is a view of the side-mounted utility holder 15, which is used as a holder for a utility knife or other hand tools.

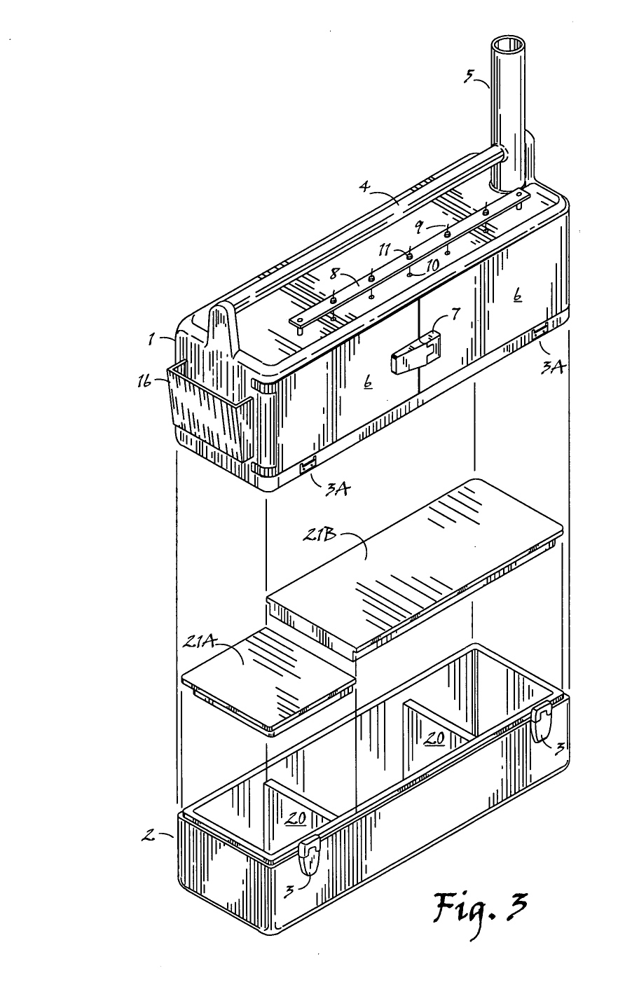

FIG. 2 illustrates a rear view of the tackle box 1 with cooler 2. The unit is in a closed position provided by the latches 3. This view also shows the handle 4 and rod holder 5. A view of the side-mounted holder for miscellaneous items 16 is also provided. A view of the ruler 17 that is used for measuring fish is also shown This rear view of the tackle box 1 shows the fishing stool 18 is a fixed position with clamps 19 holding it in place.

FIG. 3 illustrates a separated view of the upper housing 1 of the fishing tackle apparatus from the base housing 2 which is the cooler. The latches 3 are shown on the cooler 2 section with the hooks 3A being on the upper housing 1 of the tackle box. A view of the handle 4 and the rod holder 5 is shown. A view of the doors 6 are in a closed position with the latch 7. Another view of the bar 8 with the line 9 going through the line holes 10 into the line tensioner 11.

Another view of the side-mounted holder 16 for miscellaneous items is provided. A view of the cooler 2 with cooler dividers 20 is shown The dividers 20 will make separate compartments possible within the cooler for food/beverage and live bait. This illustration also shows the small lid 21A that fits over the live bait section of the cooler 2, and the larger lid 21B that fits over the food/beverage section of the cooler 2.

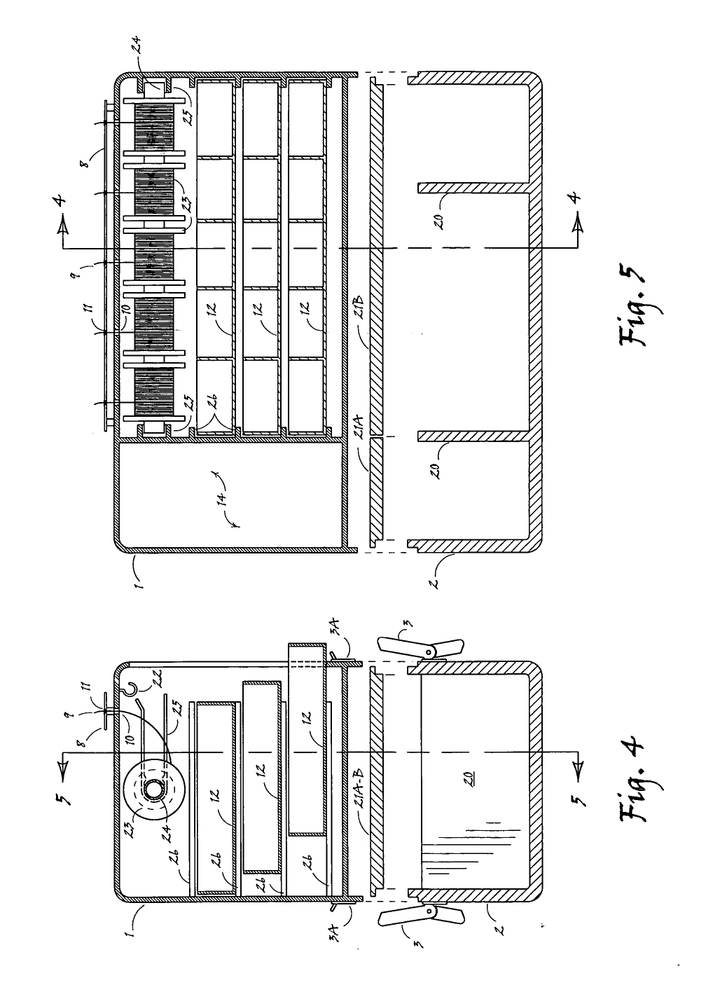

FIG. 4 illustrates a side view of the tackle box 1 with cooler 2. This view shows the latches 3 and the hooks 3A for latches 3 in an open position. This internal side view shows the bar 8 with the line 9 going through the line holes 10 located on the top of the tackle box 1 into the line tensioner 11. This illustration also gives a side view of the drawers 12 for holding hooks, weights, sinkers, and lures, with the drawer guides 26 that allow the drawers 12 to slide in and out of the tackle box 1. The leader hooks 22 are pictured for holding lures and leaders. This view also gives an overview of the assembly of the line spool 23, with the line spool rod 24, and the line spool rod guides 25. This illustration also provides a view of the divider 20 within the cooler 2, and the side view of the lids 21A, 21B, that fit over the cooler 2 sections.

FIG. 5 illustrates an open internal view of the tackle box 1 from the front. This view shows the cooler 2, with the dividers 20, and the small lid 21A that fits over the live bait compartment of the cooler 2. The large lid 21B fits over the food/beverage compartment of the cooler 2. This view provides a view of the bar 8 with the line 9 coming through the line holes 10 into the bar 8 and held with the line tensioner 1. This illusion also provides a view of the drawers 12 with the drawer guides 26, and a view of the miscellaneous storage compartment 14 that is within the tackle box 1. This view also shows the line spool 23 on the line spool rod 24, being held in place with the line spool rod guides 25.

What is claimed is:

1. A fishing tackle box comprising:
a base housing defining a bottom wall, two upstanding side wails and two upstanding end walls defining a hollow interior which is the cooler. This base housing has two separate compartments, one for food/beverages, the other for live bait;
a small lid can be fastened to the live bait side of the cooler, making this section in a closed position, and the lid lifted to allow access to this section of the cooler;
a larger lid to be fastened to the other side of the cooler, making this section in a closed position, and this lid can also be lifted to allow access to this section of the cooler which is for food/beverages;
latches on base housing located in front and rear of base in which to connect with upper housing unit to make entire tackle box in closed position;
base housing has dividers between cooler sections for live bait, and food/beverages;

2. A fishing tackle box comprising:
a upper housing defining a bottom wall, two upstanding end walls, one upstanding rear wall, a front wall that is divided for two doors to access within the tackle box, also a top wall connecting to upstanding end walls to make the upper housing part of tackle box a complete unit;
a side-mounted utility holder for a utility knife or other hand tools is located on the outside of one end of the upstanding wall;
a side-mounted holder for miscellaneous items is located on the outside of the other end of the upstanding wall;
a tackle box equipped with an outer housing made from a weather-resistant, impact resistant plastic;
a tackle box equipped with metal latches for placing the tackle box in an open or closed position;
a rod holder for placing a fishing pole;
the upper housing including tree drawers with drawer guides for easily pulling drawers out of tackle box to access compartments within drawers for holding hooks, weights, sinkers, and lures;
a detachable fishing stool which is attached to the rear of the upper housing;
a set of clamps are on the back of upstanding wall to hold fishing stool in a fixed position;
said doors in front of fishing tackle apparatus are equipped with pockets on inside of doors for holding lures;
a spool holder for holding four to five spools of fishing line; said spool holder has line spool rod, with rod guides for easily sliding line spool rod in and out of fishing tackle apparatus;
said upper housing equipped with five individual holes for threading fishing line through the top from spool holder located inside fishing apparatus;
upper housing apparatus has affixed line tensioner with bar to hold fishing line in place;
said upper housing apparatus is affixed with leader hooks on inside front top edge;
said upper housing fishing apparatus has a carrying handle which is fixed to top wall of fishing tackle box for easily carrying the tackle box;
said carrying handle has a cover for comfort;
a ruler which is mounted on outside top wall for measuring fish.
